(19) United States
(12) Patent Application Publication
(10) Pub. No.: US 2018/0290848 A1
(43) Pub. Date: Oct. 11, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Hiroyuki TAKI, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/684,128

(22) Filed: Aug. 23, 2017

(30) Foreign Application Priority Data
Apr. 7, 2017 (JP) 2017-076752

(51) Int. Cl. B65H 5/36; G03G 15/20; G03G 15/00

(52) U.S. Cl. CPC B65H 5/36; G03G 15/2071; B65H 29/52; G03G 2215/00679; G03G 15/6529

(57) ABSTRACT

An image forming apparatus includes an image forming section, a guide, a conveyance roller and a movement mechanism. The image forming section forms an image on an image receiving medium. The guide is arranged at a downstream side of the image forming section in a conveyance direction of the image receiving medium. The guide guides the image receiving medium. The conveyance roller is arranged at the downstream side of the image forming section in the conveyance direction of the image receiving medium. The conveyance roller conveys the image receiving medium along the guide. The movement mechanism moves at least one of the guide or the conveyance roller in a direction intersecting the conveyance direction of the image receiving medium.

### CROSS-REFERENCE TO RELATED APPLICATION

This application is based upon and claims the benefit of priority from Japanese Patent Application No. 2017-076752, filed Apr. 7, 2017, the entire contents of which are incorporated herein by reference.

### FIELD

Embodiments described herein relate generally to an image forming apparatus.

### BACKGROUND

There is an image forming apparatus such as a Multi-Function Peripheral (hereinafter, referred to as an “MFP”) or a printer. The image forming apparatus forms an image while conveying a sheet-like recording medium such as a paper (hereinafter, collectively referred to as a “sheet”). The image forming apparatus includes a fixing device, a guide and a conveyance roller. The fixing device fixes an image by applying heat and pressure to the sheet. The sheet includes a label sheet containing a label main body having an adhesive surface such as a pasted surface and a mount adhering to the adhesive surface.

In a case of conveying the label sheet, the label sheet is heated by passing through the fixing device, and thus, there is a case in which a small amount of glue protrudes from a sheet edge. If the glue protrudes from the sheet edge, there is a case in which the glue adheres to the guide or the conveyance roller. If the glue adheres to the guide or the conveyance roller, the glue is stacked on the guide or the conveyance roller, and thus, there is a possible that a conveyance jam occurs.

### DESCRIPTION OF THE DRAWINGS

FIG. 1 is a schematic diagram of an image forming apparatus according to an embodiment;

FIG. 2 is a diagram of a fixing device according to the embodiment;

FIG. 3 is a diagram of a sheet discharge unit according to the embodiment;

FIG. 4 is a perspective view of the arrangement relationship between a guide and a conveyance roller according to the embodiment;

FIG. 5 is an exploded perspective view of the sheet discharge unit according to the embodiment;

FIG. 6 is a plan view of a label sheet according to the embodiment;

FIG. 7 is a sectional view along VII-VII in FIG. 6;

FIG. 8 is a plan view illustrating a home position of the sheet discharge unit according to the embodiment;

FIG. 9 is a plan view illustrating the function of a movement mechanism according to the embodiment;

FIG. 10 is a plan view illustrating the function of the movement mechanism according to the embodiment; and

FIG. 11 is a block diagram of functional components of the image forming apparatus according to the embodiment.

### DETAILED DESCRIPTION

In accordance with an embodiment, an image forming apparatus comprises an image forming section, a guide, a conveyance roller and a movement mechanism. The image forming section forms an image on an image receiving medium. The guide is arranged at a downstream side of the image forming section in a conveyance direction of the image receiving medium. The guide guides the image receiving medium. The conveyance roller is arranged at the downstream side of the image forming section in the conveyance direction of the image receiving medium. The conveyance roller conveys the image receiving medium along the guide. The movement mechanism moves at least one of the guide and the conveyance roller in a direction intersecting the conveyance direction of the image receiving medium.

Hereinafter, an image forming apparatus of an embodiment is described with reference to the accompanying drawings. Furthermore, in each diagram, the same component is given the same reference numeral.

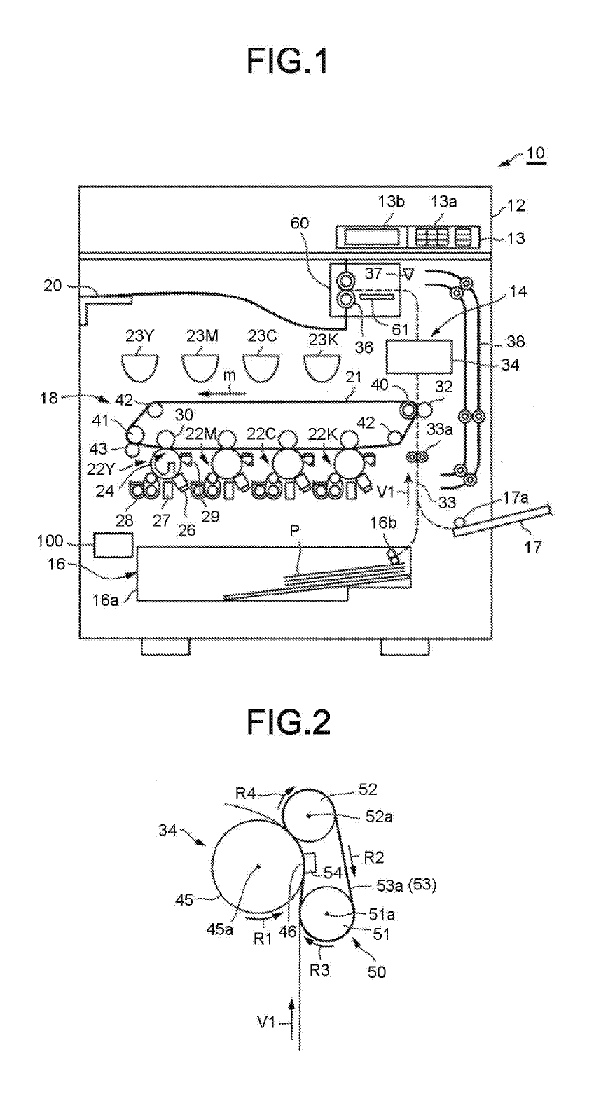

FIG. 1 is a side view of an image forming apparatus 10 according to the embodiment. Hereinafter, as an example of the image forming apparatus 10, an MFP 10 is exemplified.

As shown in FIG. 1, the MFP 10 includes a scanner 12, a control panel 13 and a main body section 14. The scanner 12, the control panel 13 and the main body section 14 each include a controller. The MFP 10 includes a system controller 100 for collectively controlling each controller. The main body section 14 includes a sheet feed cassette section 16, a printer section 18 (image forming section) and a sheet discharge unit 60.

The scanner 12 reads an image of an original document. The control panel 13 includes an input key 13a and a display section 13b. For example, the input key 13a receives an input by a user. For example, the display section 13b is a touch panel type. The display section 13b receives an input by the user and displays it to the user.

The sheet feed cassette section 16 includes a sheet feed cassette 16a and a pickup roller 16b. The sheet feed cassette 16a houses a sheet P which is the image receiving medium, also known as image recording medium. In the embodiment, the sheet P includes a label sheet. The pickup roller 16b picks up the sheet P from the sheet feed cassette 16a.

The sheet feed cassette 16a feeds an unused sheet P. A sheet feed tray 17 feeds the unused sheet P with a pickup roller 17a.

The printer section 18 executes an image formation. For example, the printer section 18 forms an image of the original document read by the scanner 12. The printer section 18 includes an intermediate transfer belt 21. The printer section 18 supports the intermediate transfer belt 21 with a backup roller 40, a driven roller 41 and a tension roller 42. The backup roller 40 includes a driving section (not shown). The printer section 18 rotates the intermediate transfer belt 21 in an arrow m direction.

The printer section 18 includes four sets of image forming stations 22Y, 22M, 22C and 22K. The image forming stations 22Y, 22M, 22C and 22K are used for forming images of Y (yellow), M (magenta), C (cyan) and K (black), respectively. The image forming stations 22Y, 22M, 22C and 22K are arranged in parallel along a rotation direction of the intermediate transfer belt 21 at the lower side of the intermediate transfer belt 21.

The printer section 18 includes cartridges 23Y, 23M, 23C and 23K above the image forming stations 22Y, 22M, 22C and 22K. The cartridges 23Y, 23M, 23C and 23K store toner for replenishment of Y (yellow), M (magenta), C (cyan) and K (black), respectively.

The description below is given by taking the image forming station 22Y of Y (yellow) as an example among the image forming stations 22Y, 22M, 22C and 22K. The image forming stations 22M, 22C and 22K have the same arrangement as the image forming station 22Y, and thus a detailed description thereof is omitted.

The image forming station 22Y includes an electric charger 26, an exposure scanning head 27, a developing device 28 and a photoconductor cleaner 29. The electric charger 26, the exposure scanning head 27, the developing device 28 and the photoconductor cleaner 29 are arranged around the photoconductive drum 24 rotating in an arrow n direction.

The image forming station 22Y includes a primary transfer roller 30. The primary transfer roller 30 faces the photoconductive drum 24 across the intermediate transfer belt 21.

The image forming station 22Y charges the photoconductive drum 24 with the electric charger 26 and then exposes it with the exposure scanning head 27. The image forming station 22Y forms an electrostatic latent image on the photoconductive drum 24. The developing device 28 develops the electrostatic latent image on the photoconductive drum 24 using a two-component developer formed by toner and carrier.

The primary transfer roller 30 primarily transfers the toner image formed on the photoconductive drum 24 onto the intermediate transfer belt 21. The image forming stations 22Y, 22M, 22C and 22K form a color toner image on the intermediate transfer belt 21 with the primary transfer roller 30. The color toner image is formed by sequentially superimposing toner images of Y (yellow), M (magenta), C (cyan) and K (black). The photoconductor cleaner 29 removes the toner remaining on the photoconductive drum 24 after the primary transfer.

The printer section 18 includes a secondary transfer roller 32. The secondary transfer roller 32 faces the backup roller 40 across the intermediate transfer belt 21. The secondary transfer roller 32 secondarily transfers the color toner image on the intermediate transfer belt 21 onto the sheet P collectively. The sheet P is fed from the sheet feed cassette section 16 or the sheet feed tray 17 along a conveyance path 33.

The printer section 18 includes a belt cleaner 43 opposite to the driven roller 41 across the intermediate transfer belt 21. The belt cleaner 43 removes the toner remaining on the intermediate transfer belt 21 after the secondary transfer.

The printer section 18 includes a resist roller 33a and a fixing device 34 along the conveyance path 33. The printer section 18 includes a bifurcating section 37 and a reverse conveyance section 38 at the downstream of the fixing device 34. The bifurcating section 37 sends the sheet P after fixing to the sheet discharge unit 60 or the reverse conveyance section 38. In the case of duplex printing, the reverse conveyance section 38 conveys the sheet P sent from the bifurcating section 37 in a direction of the resist roller 33a by reversing the sheet P. The MFP 10 forms a fixed toner image on the sheet P with the printer section 18. The MFP 10 discharges the sheet P after fixing to a sheet discharge section 20 via the sheet discharge unit 60.

The MFP 10 is not limited to a tandem development system and the number of the developing devices 28 is not limited. The MFP 10 may directly transfer the toner image from the photoconductive drum 24 onto the sheet P.

As mentioned above, the sheet P is conveyed from the sheet feed cassette section 16 to the sheet discharge section 20.

Hereinafter, the sheet feed cassette section 16 side is referred to as an “upstream side” in the conveyance direction V1 of the sheet P (hereinafter, also referred to as a “sheet conveyance direction V1”). In the sheet conveyance direction V1, the sheet discharge section 20 side is referred to as a “downstream side”.

Next, the fixing device 34 is described.

FIG. 2 is a diagram of the fixing device 34 according to the embodiment.

As shown in FIG. 2, the fixing device 34 includes a heat roller 45 (heating section) and a pressure unit 50. The fixing device 34 applies heat and pressure to the sheet to fix the image.

First, the heat roller 45 (rotating body) which is a heating unit is described.

The heat roller 45 is arranged at the downstream side of the intermediate transfer belt 21 (refer to FIG. 1) in the sheet conveyance direction V1. The heat roller 45 is an endless fixing member. The heat roller 45 has a curved outer peripheral surface. The heat roller 45 has a cylindrical shape. The heat roller 45 has a metal roller. For example, the heat roller 45 has a resin layer such as fluororesin on the outer peripheral surface of a roller made of aluminum. The heat roller 45 is rotatable around a first axis 45a. The first axis 45a means a central axis (rotational axis) of the heat roller 45.

The fixing device 34 further includes a heat source (not shown) for heating the heat roller 45. For example, the heat source may be a resistance heating element such as a thermal head, a ceramic heater, a halogen lamp, an electromagnetic induction heating unit, or the like. The heat source may be arranged at the inner side or outer side of the heat roller 45.

The pressure unit 50 is described.

The pressure unit 50 includes a plurality of rollers 51 and 52, a belt 53 (rotating body) and a pressure pad 54 (pressure member).

The plurality of rollers 51 and 52 is arranged within the belt 53. In the present embodiment, each of the plurality of rollers 51 and 52 are composed of a first roller 51 and a second roller 52. The plurality of rollers 51 and 52 may be the same roller or different rollers.

The plurality of rollers 51 and 52 are rotatable around a plurality of rotation axes 51a and 52a parallel to the first axis 45a. The plurality of rollers 51 and 52 are arranged at positions that contribute to the formation of a nip 46.

The first roller 51 is arranged at the upstream side of the second roller 52 in the sheet conveyance direction V1. The first roller 51 has a columnar shape. For example, the first roller 51 is made of metal such as iron. The first roller 51 is rotatable around a first rotation axis 51a parallel to the first axis 45a. The first rotation axis 51a means a central axis of the first roller 51.

The second roller 52 is arranged at the downstream side of the first roller 51 in the sheet conveyance direction V1. The second roller 52 has a cylindrical shape. For example, the second roller 52 is made of metal such as iron. The second roller 52 is rotatable about a second rotation axis 52a parallel to the first axis 45a. The second rotation axis 52a means a central axis of the second roller 52.

The belt 53 faces the heat roller 45. The belt 53 is stretched over the first roller 51 and the second roller 52. The belt 53 has an endless shape.

The belt 53 includes a base layer 53a and a release layer (not shown). For example, the base layer 53a is formed of polyimide resin (PI). For example, the release layer is formed of a fluororesin such as tetrafluoroethylene·perfluoroalkyl vinyl ether copolymer resin (PFA). The layer structure of the belt 53 is not limited thereto. The belt 53 includes a film-like member.

The pressure pad 54 has a rectangular parallelepiped shape. For example, the pressure pad 54 is formed of a resin material such as heat resistant polyphenylene sulfide resin (PPS), liquid crystal polymer (LCP), phenol resin (PF) or the like. The pressure pad 54 is arranged at a position facing the heat roller 45 across the belt 53. The pressure pad 54 is energized toward the heat roller 45 by an energizing member (not shown) such as a spring. The pressure pad 54 abuts against an inner peripheral surface of the belt 53 to press the belt 53 against the heat roller 45 to form the nip 46. The pressure pad 54 presses the inner peripheral surface of the belt 53 toward the heat roller 45 side, thereby forming the nip 46 between the belt 53 and the heat roller 45.

The rotation direction of the heat roller 45 is described.

The heat roller 45 rotates in an arrow R1 direction by a motor (not shown). The heat roller 45 rotates independently of the pressure unit 50 in the arrow R1 direction. In the embodiment, the heat roller 45 is a driving roller.

The belt 53 is driven by the heat roller 45 and rotates in an arrow R2 direction. The belt 53 abuts against the outer peripheral surface of the heat roller 45 that rotates in the arrow R1 direction, thereby rotating accordingly.

The first roller 51 is driven by the belt 53 and rotates in an arrow R3 direction. The second roller 52 is driven by the belt 53 and rotates in an arrow R4 direction. The first roller 51 and the second roller 52 are driven to rotate by contacting with the inner peripheral surface of the belt 53 rotating in the arrow R2 direction.

The sheet discharge unit 60 is described.

As shown in FIG. 1, the sheet discharge unit 60 is arranged between the fixing device 34 and the sheet discharge section 20 in the sheet conveyance direction V1. The sheet discharge unit 60 is located at the downstream side of the fixing device 34 in the sheet conveyance direction V1.

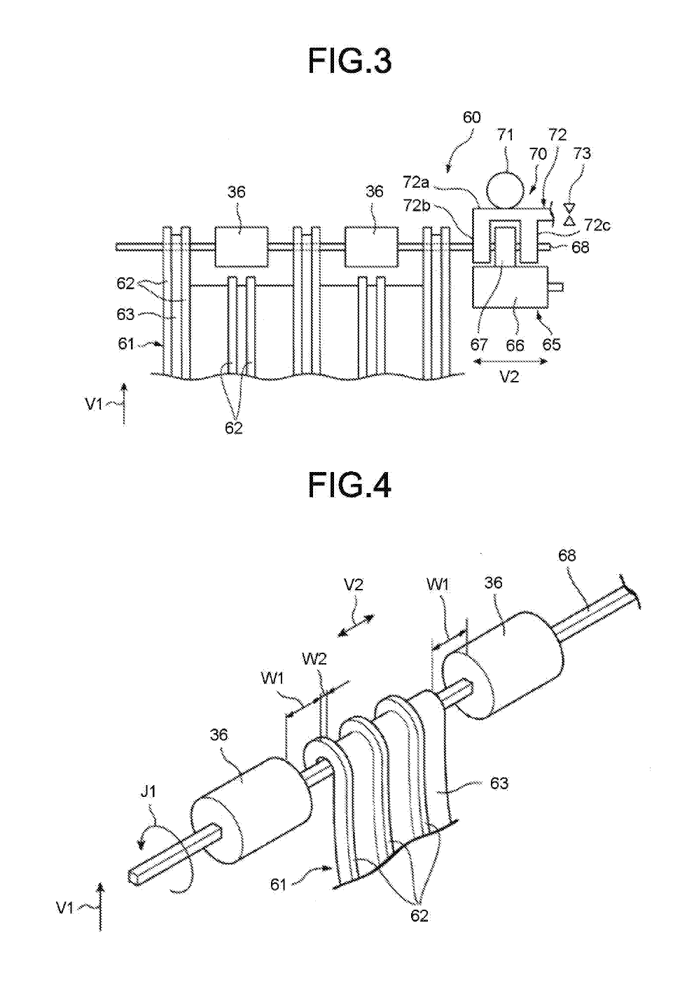

FIG. 3 is a diagram of the sheet discharge unit 60 according to the embodiment.

As shown in FIG. 3, the sheet discharge unit 60 includes a guide 61, a conveyance roller 36, a drive mechanism 65 and a movement mechanism 70.

The guide 61 and the conveyance roller 36 are located at the downstream side of the fixing device 34 in the sheet conveyance direction V1 (refer to FIG. 1). The guide 61 guides the sheet P. The guide 61 is located in the area avoiding the conveyance roller 36. The guide 61 includes a guide rib 62 and a rib connection section 63.

The guide rib 62 protrudes toward the sheet P conveyed along the sheet conveyance direction V1. The guide rib 62 extends along the sheet conveyance direction V1. A plurality of the guide ribs 62 is arranged at intervals in a direction V2 (hereinafter, referred to as a “sheet width direction V2”) which is parallel to a surface of the sheet P and orthogonal to the sheet conveyance direction V1.

The rib connection section 63 connects the two guide ribs 62 adjacent to each other in the sheet width direction V2. The rib connection section 63 has a thickness in a normal line direction of one surface of the sheet P conveyed along the sheet conveyance direction V1. The rib connection section 63 functions as a reinforcing section of the guide 61.

FIG. 4 is a perspective view of the arrangement relationship between the guide 61 and the conveyance roller 36 according to the embodiment.

As shown in FIG. 4, the conveyance roller 36 has a cylindrical shape. The conveyance roller 36 conveys the sheet P along the guide 61. The conveyance roller 36 is a paper discharge roller that discharges the sheet P after fixing to the sheet discharge section 20 (refer to FIG. 1). The conveyance roller 36 is fixed to a shaft 68 having a length in the sheet width direction V2. A plurality of the conveyance rollers 36 is arranged at intervals in the sheet width direction V2. The conveyance roller 36 and the shaft 68 are provided in an area avoiding the guide 61.

The guide 61 is arranged apart from the two conveyance rollers 36 adjacent to each other in the sheet width direction V2. In the sheet width direction V2, a distance W1 between the guide 61 and the conveyance roller 36 is larger than a width W2 of the guide rib 62 (W1>W2). A downstream end of the guide rib 62 in the sheet conveyance direction V1 is curved to avoid the shaft 68.

The drive mechanism 65 is described.

As shown in FIG. 3, the drive mechanism 65 includes a drive mechanism side motor (not shown), a driving gear 66 and a driven gear 67. The driving gear 66 transmits a driving force of the drive mechanism side motor to the driven gear 67. The driven gear 67 is fixed to the shaft 68.

The conveyance roller 36 rotates in a direction of the arrow J1 by driving of the drive mechanism side motor (refer to FIG. 4). For the sake of convenience, teeth in the driving gear 66 and the driven gear 67 in FIG. 3 are not shown. The driving gear 66 and the driven gear 67 are mutually movable in the sheet width direction V2.

The movement mechanism 70 is described.

The movement mechanism 70 moves the guide 61 and the conveyance roller 36 in a direction intersecting the sheet conveyance direction V1. In the embodiment, the movement mechanism 70 moves the guide 61 and the conveyance roller 36 in the sheet width direction V2.

As shown in FIG. 3, the movement mechanism 70 includes a movement mechanism side motor (not shown), a pinion gear 71, a rack member 72, and a position sensor 73. The pinion gear 71 transmits a driving force of the movement mechanism side motor to the rack member 72. The rack member 72 is fixed to the shaft 68 via a bearing (not shown). For the sake of convenience, in FIG. 3 and other figures, teeth of the pinion gear 71 and the rack member 72 (rack section 72a) are not shown.

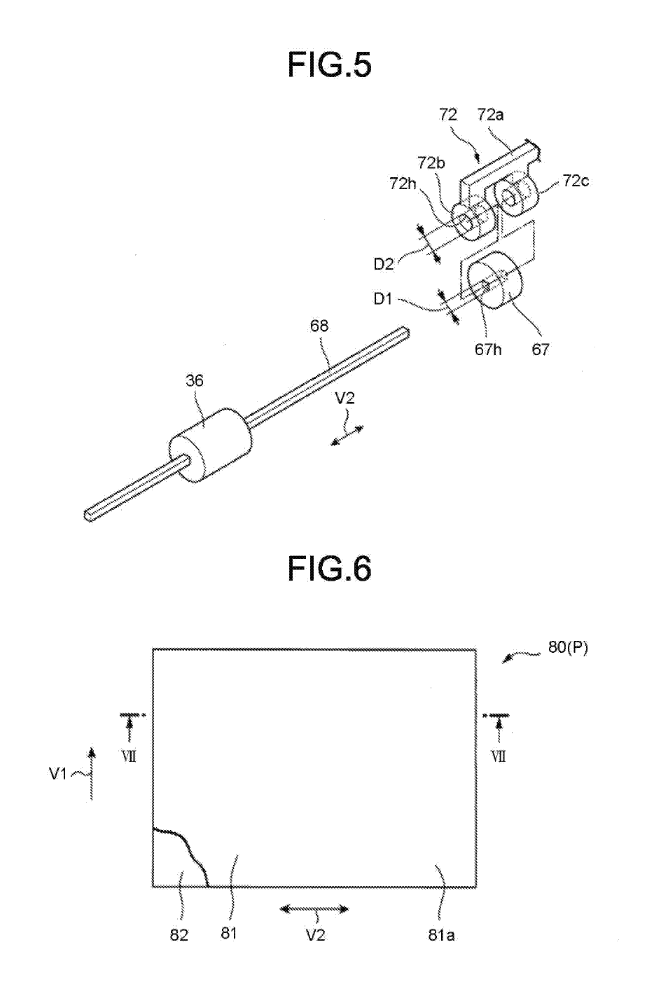

FIG. 5 is an exploded perspective view of the sheet discharge unit 60.

As shown in FIG. 5, the rack member 72 includes a rack section 72a and a pair of support pieces 72b and 72c. The rack section 72a extends in the sheet width direction V2. The rack section 72a changes a rotational motion of the pinion gear 71 (refer to FIG. 3) to a linear motion parallel to the sheet width direction V2. The rack section 72a and the pinion gear 71 (refer to FIG. 3) constitute a rack and pinion mechanism.

A pair of support pieces 72b and 72c extends from the rack section 72a toward both sides of the driven gear 67 in the drive mechanism 65 (refer to FIG. 3). In the pair of support pieces 72b and 72c, a circular through hole 72h opening in the sheet width direction V2 is formed. On the other hand, in the driven gear 67, a rectangular through hole 67h opening in the sheet width direction V2 is formed. The prismatic shaft 68 is inserted through the through hole 67h of the driven gear 67.

A diameter D2 of the through hole 72h in each of support pieces 72b and 72c is larger than a maximum length D1 of the through hole 67h in the driven gear 67 (D2>D1). The maximum length D1 of the through hole 67h in the driven gear 67 is a length of the diagonal of the rectangular through hole 67h. The length of the diagonal of the rectangular through hole 67h corresponds to a maximum width of the prismatic shaft 68. In other words, the diameter D2 of the through hole 72h in each of the support pieces 72b and 72c is larger than the maximum width of the prismatic shaft 68.

In the through hole 72h of each of the support pieces 72b and 72c, a bearing (not shown) for rotatably supporting the shaft 68 is provided. The rack member 72 regulates movement of the shaft 68 in the sheet width direction V2 while allowing rotation of the shaft 68. As the rack member 72 moves in the sheet width direction V2, the conveyance roller 36 fixed to the shaft 68 also moves in the sheet width direction V2.

As shown in FIG. 3, the rack member 72 is connected to the guide 61 via a connection member (not shown). The rack member 72 regulates the movement of the guide 61 in the sheet width direction V2. As the rack member 72 moves in the sheet width direction V2, the guide 61 also moves in the sheet width direction V2.

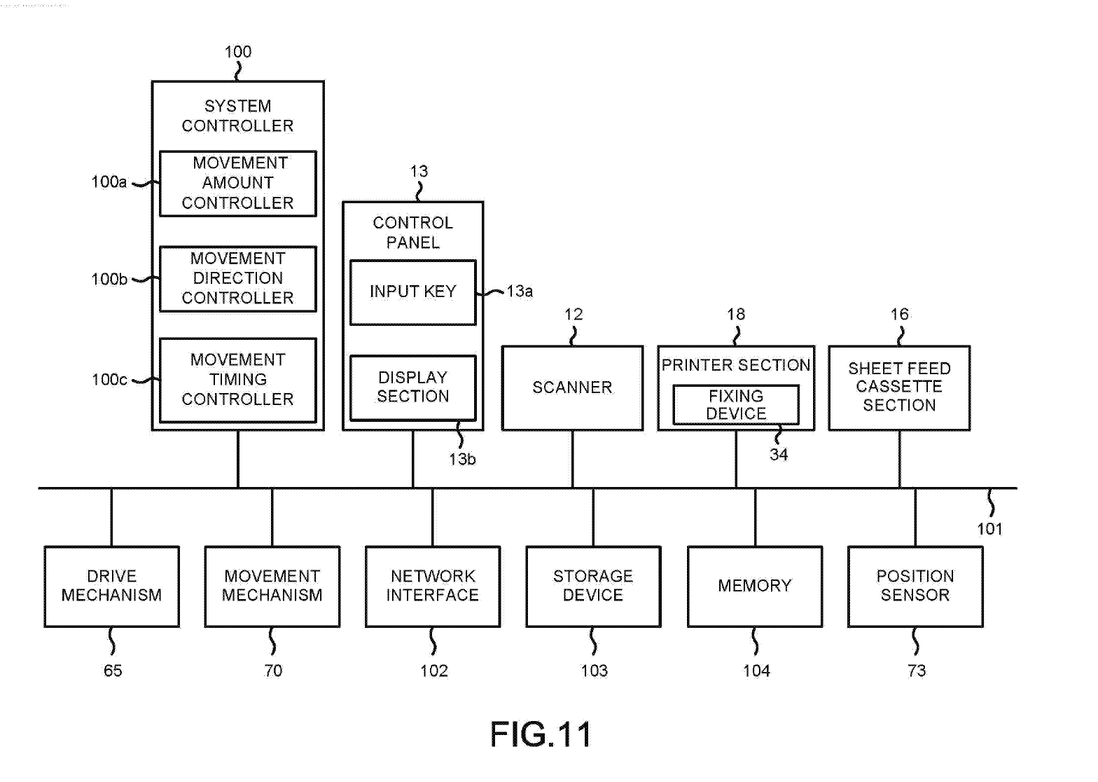

The position sensor 73 detects a movement amount and a movement direction of the rack member 72 in the sheet width direction V2. For example, the position sensor 73 is a non-contact sensor such as a laser displacement meter or an ultrasonic sensor. The detection result of the position sensor 73 is output to the system controller 100 (refer to FIG. 11) as a detection signal of the movement amount and movement direction of the rack member 72 in the sheet width direction V2.

The sheet P is described.

In the embodiment, the sheet P includes the label sheet.

FIG. 6 is a plan view of a label sheet 80 according to the embodiment.

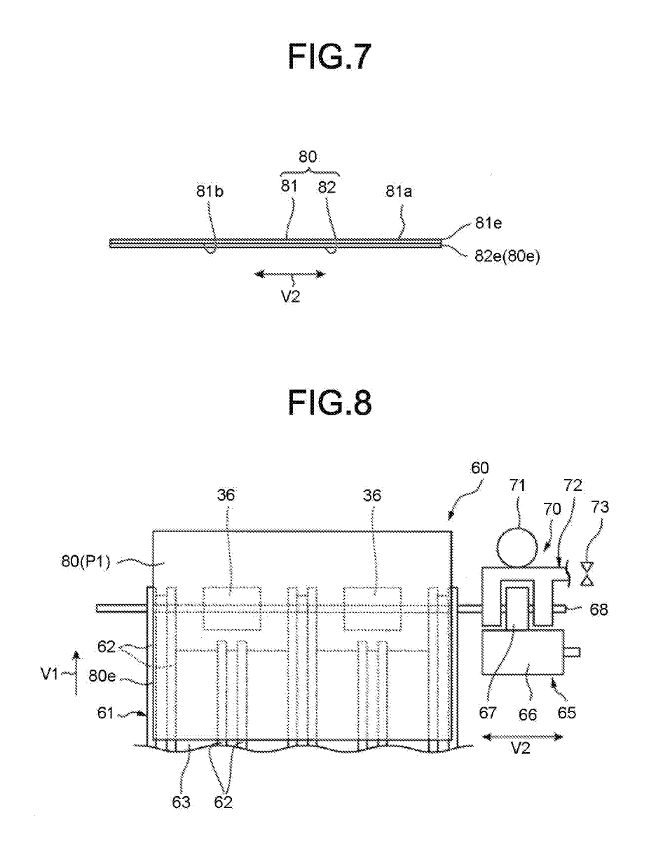

As shown in FIG. 6, the label sheet 80 includes a label paper 81 and a mount 82. In the label paper 81, a first surface which is one of a front surface and a back surface is set as a printing surface 81a. In the label paper 81, the other one of the front surface and the back surface is set as an adhesive surface 81b (refer to FIG. 7) coated with an adhesive such as a glue.

FIG. 7 is a sectional view along VII-VII in FIG. 6.

As shown in FIG. 7, the mount 82 is attached to the adhesive surface 81b of the label paper 81 in a peelable manner. The mount 82 protects an adhesive layer from the second surface side of the label paper 81.

For example, the label sheet 80 is a fixed single sheet such as A4 or B5. The mount 82 has substantially the same contour as the label paper 81. An edge 82e of the mount 82 substantially overlaps with an edge 81e of the label paper 81 in a thickness direction of the label sheet 80. No margin is provided between the edge 82e of the mount 82 and the edge 81e of the label paper 81. The edge 82e of the mount 82 constitutes an edge 80e (hereinafter, also referred to as a “sheet edge 80e”) of the label sheet 80. Hereinafter, the sheet edge 80e in the sheet width direction V2 is also referred to as a “sheet width direction edge 80e”.

The function of the movement mechanism 70 is described.

The system controller 100 (refer to FIG. 11) controls the movement mechanism 70 in such a manner that the guide 61 and the conveyance roller 36 move in the sheet width direction V2.

FIG. 8 is a plan view illustrating a home position of the sheet discharge unit 60 according to the embodiment.

The home position of the sheet discharge unit 60 is a reference position before the guide 61 and the conveyance roller 36 move in the sheet width direction V2. As shown in FIG. 8, at the home position, the guide rib 62 overlaps with the sheet width direction edge 80e.

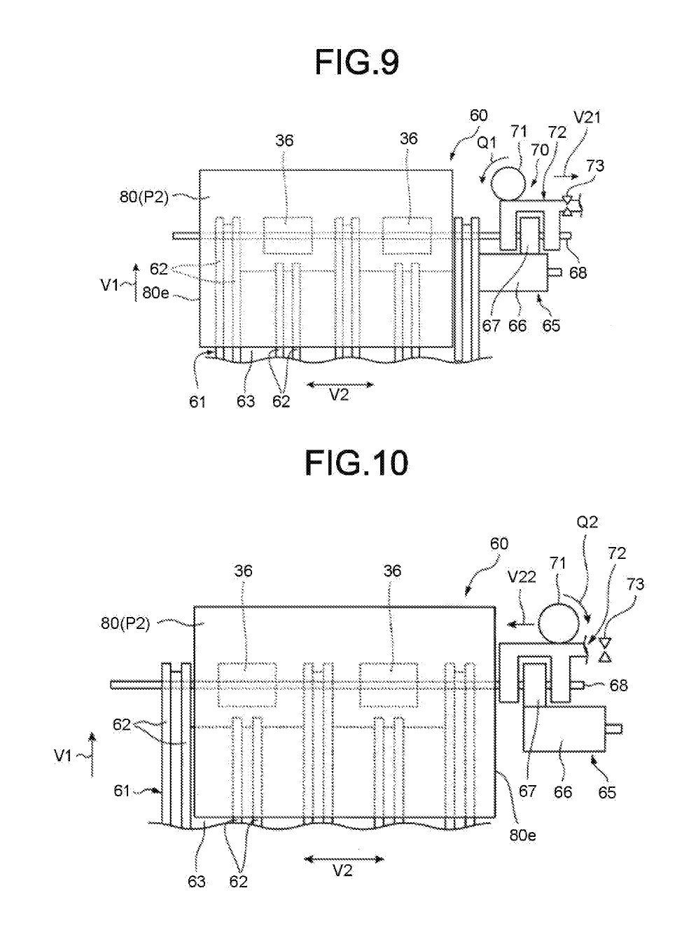

FIG. 9 and FIG. 10 are plan views illustrating the function of the movement mechanism 70 according to the embodiment.

FIG. 9 shows a state (hereinafter, also referred to as a “first movement state”) in which the guide 61 and the conveyance roller 36 are moved in a first direction V21 which is one side of the sheet width direction V2. In the first movement state, the pinion gear 71 rotates in an arrow Q1 direction and the rack member 72 moves in the first direction V21, and in this way, the guide 61 and the conveyance roller 36 move in the first direction V21. In the first movement state, the guide rib 62 located at the side opposite to the first direction V21 is arranged at the inside of the sheet width direction edge 80e.

FIG. 10 shows a state (hereinafter, also referred to as a “second movement state”) in which the guide 61 and the conveyance roller 36 move in a second direction V22 which is the other side of the sheet width direction V2. In the second movement state, the pinion gear 71 rotates in an arrow Q2 direction and the rack member 72 moves in the second direction V22, and in this way, the guide 61 and the conveyance roller 36 move in the second direction V22. The second direction V22 is a direction opposite to the first direction V21 (refer to FIG. 9). In the second movement state, the guide rib 62 located at the side opposite to the second direction V22 is arranged at the inside of the sheet width direction edge 80e.

The control of the movement mechanism 70 is described. For example, the control of the movement mechanism 70 is executed based on an instruction input by the user to the control panel 13 (refer to FIG. 11). The control of the movement mechanism 70 is executed based on scan data including sheet information such as a sheet size, print data, coordinate data and the like.

The system controller 100 (refer to FIG. 11) includes a movement amount controller 100a for controlling movement amount of the guide 61 and the conveyance roller 36 in such a manner that the guide 61 and the conveyance roller 36 move towards the inside of the sheet width direction edge 80e of the label sheet 80 one sheet before in the sheet width direction V2.

For example, the movement amount controller 100a controls the movement mechanism 70 in such a manner that the guide rib 62 moves to the inside of the sheet width direction edge 80e of the first sheet P1 in a case in which the guide rib 62 overlaps with the sheet width direction edge 80e of the label sheet 80 (hereinafter, also referred to as a “first sheet P1”) at the home position. The movement mechanism 70 moves the guide 61 and the conveyance roller 36 in the first direction V21 (refer to FIG. 9) or the second direction V22 (refer to FIG. 10) and moves the guide rib 62 to the inside of the sheet width direction edge 80e of the first sheet P1. By moving the guide rib 62 to the inside of the sheet width direction edge 80e of the first sheet P1, the guide rib 62 can be positioned at the inside of the sheet width direction edge 80e of the label sheet 80 (hereinafter, also referred to as a “second sheet P2”) next to the first sheet P1 (refer to FIG. 9 and FIG. 10).

If a plurality of the label sheets 80 having substantially the same size are conveyed consecutively, the system controller 100 (refer to FIG. 11) includes a movement direction controller 100b for controlling the movement direction of the guide 61 and the conveyance roller 36 in such a manner that the guide 61 and the conveyance roller 36 move alternately in the sheet width direction V2 each time one label sheet 80 is conveyed.

For example, the movement direction controller 100b controls the movement mechanism 70 in such a manner that the guide 61 and the conveyance roller 36 alternately move in the first direction V21 (refer to FIG. 9) and the second direction V22 (refer to FIG. 10) each time one label sheet 80 is conveyed if a plurality of the label sheets 80 having substantially the same size are conveyed consecutively. The movement mechanism 70 moves the guide 61 and the conveyance roller 36 alternately in the first direction V21 (refer to FIG. 9) and in the second direction V22 (refer to FIG. 10) to alternately repeat a state (hereinafter, also referred to as an “overlapping state”) in which the guide rib 62 overlaps with the width direction edge 80e and a state (hereinafter also referred to as an “inside arrangement state”) in which the guide rib 62 is located at the inside of the sheet width direction edge 80e. By alternately repeating the overlapping state and the inside arrangement state, it is possible to avoid the situation where the guide rib 62 continues to overlap with the sheet width direction edge 80e at the same position.

The system controller 100 (refer to FIG. 11) further includes a movement timing controller 100c for controlling a movement timing of the guide 61 and the conveyance roller 36 to stop the movement of the guide 61 and the conveyance roller 36 in the sheet width direction V2 if a width of the label sheet 80 to be conveyed next differs from that of the label sheet 80 one sheet before. The width of the label sheet 80 means a length of the label sheet 80 in the sheet width direction V2.

A case in which the width of the label sheet 80 to be conveyed next is different from that of the label sheet 80 one sheet before refers to that the width of the label sheet 80 to be conveyed next is larger than or smaller than that of the label sheet 80 one sheet before.

For example, if the width of the label sheet 80 to be conveyed next is a B5 size width and the width of the label sheet 80 one sheet before is an A4 size width, the movement timing controller 100c controls the movement mechanism 70 to stop the movement of the guide 61 and the conveyance roller 36 in the sheet width direction V2. The guide mechanism 70 stops the movement of the guide 61 and the conveyance roller 36 in the sheet width direction V2 so that an overlapping position of a label sheet edge of A4 size and an overlapping position of a label sheet edge of B5 size are different from each other with respect to the guide rib 62 in the sheet width direction V2.

For example, if the width of the label sheet 80 to be conveyed next is the A4 size width and the width of the label sheet 80 one sheet before is the B5 size width, the movement timing controller 100c controls the movement mechanism 70 to stop the movement of the guide 61 and the conveyance roller 36 in the sheet width direction V2. The movement mechanism 70 stops the movement of the guide 61 and the conveyance roller 36 in the sheet width direction V2 so that the guide rib 62 overlapping with the label sheet edge of B5 size can be arranged inside the label sheet edge of A4 size in the sheet width direction V2.

The functional components of the image forming apparatus 10 are described.

FIG. 11 is a block diagram of functional components of the image forming apparatus 10 according to the embodiment.

As shown in FIG. 11, each functional section of the image forming apparatus 10 is connected to be capable of executing data communication through a system bus line 101.

The system controller 100 controls the operation of each functional section of the image forming apparatus 10. The system controller 100 executes various processing by executing programs. The system controller 100 acquires an instruction input by the user from the control panel 13. The system controller 100 executes a control processing based on the acquired instruction.

A network interface 102 transmits and receives data to and from other devices. The network interface 102 operates as an input interface to receive data transmitted from other devices. The network interface 102 also operates as an output interface to transmit data to other devices.

The storage device 103 stores various data. For example, the storage device 103 is a hard disk or an SSD (Solid State Drive). For example, various data are digital data, screen data of a setting screen, setting information, a job, job log, and the like. Various data includes the scan data including the sheet information such as the sheet size, the print data, the coordinate data, and the like. The digital data is generated by the scanner 12. The setting screen is used for setting operation of the movement mechanism 70. The setting information relates to an operation setting of the movement mechanism 70.

The memory 104 temporarily stores data used by each functional section. For example, the memory 104 is a RAM (Random Access Memory). For example, the memory 104 temporarily stores the digital data, the jobs, the job log, and the like.

In a case of conveying the label sheet, there is a case in which a little amount of the glue protrudes from the sheet edge by being heated at the time the label sheet passes through the fixing device. If the glue protrudes from the sheet edge, the glue adheres to the guide or the conveyance roller in some cases. If the glue adheres to the guide or the conveyance roller, a conveyance jam may occur due to accumulation of the glue on the guide or the conveyance roller.

According to the embodiment, the image forming apparatus includes the printer section 18, the guide 61, the conveyance roller 36 and the movement mechanism 70. The printer section 18 forms an image on the label sheet 80. The guide 61 is located at the downstream side of the printer section 18 in the sheet conveyance direction V1. The guide 61 guides the label sheet 80. The conveyance roller 36 is located at the downstream side of the printer section 18 in the sheet conveyance direction V1. The conveyance roller 36 conveys the label sheet 80 along the guide 61. The movement mechanism 70 moves the guide 61 and the conveyance roller 36 in the sheet width direction V2. With the above arrangement, the following effects are achieved. The guide 61 and the conveyance roller 36 move in the sheet width direction V2, and thus, even if the glue protrudes from the sheet width direction edge 80e, it is possible to suppress adhesion of the glue moves to the same place of the guide 61 or the conveyance roller 36. By suppressing the glue from adhering to the same place of the guide 61 or the conveyance roller 36, it is possible to suppress the glue from stacking in the same place of the guide 61 or the conveyance roller 36. Consequently, it is possible to suppress the conveyance jam.

The system controller 100 includes the movement amount controller 100a for controlling the movement amount of the guide 61 and the conveyance roller 36 in such a manner that the guide 61 and the conveyance roller 36 move towards the inside of edge 80e of the label sheet 80 (first sheet P1) one sheet before in the sheet width direction V2, and in this way, the following effects are achieved. By moving the guide rib 62 towards the inside of the sheet width direction edge 80e of the first sheet P1, the guide rib 62 can be positioned at the inside of the sheet width direction edge 80e of the label sheet 80 (second sheet P2) conveyed next to the first sheet Pl. Even if the glue protruding from the sheet width direction edge 80e of the first sheet P1 adheres to the guide rib 62, the glue attached to the guide rib 62 can be transferred onto the second sheet P2. By transferring the glue adhering to the guide rib 62 onto the second sheet P2, the glue adhering to the guide rib 62 can be cleaned. Consequently, it is possible to suppress the conveyance jam.

The system controller 100 further includes the movement direction controller 100b for controlling the movement direction of the guide 61 and the conveyance roller 36 in such a manner that the guide 61 and the conveyance roller 36 move alternately in the sheet width direction V2 each time one label sheet 80 is conveyed if a plurality of the label sheets 80 is continuously conveyed, and in this way, the following effects are achieved. By alternatively repeating the state (overlapping state) in which the guide rib 62 overlaps with the width direction edge 80e and the state (inside arrangement state) in which the guide rib 62 is located at the inside of the sheet width direction edge 80e through moving the guide 61 and the conveyance roller 36 alternately in the first direction V21 and the second direction V22, it is possible to above that the guide rib 62 continues to overlap with the sheet width direction edge 80e at the same position. By avoiding the situation where the guide rib 62 continues to overlap with the sheet width direction edge 80e at the same position, even if the glue protrudes from the sheet width direction edge 80e, it is possible to suppress the glue from stacking in the same place in the guide 61. Thus, the conveyance jam can be suppressed.

In particular, if plural label sheets 80 of the same size are conveyed in succession, even if the glue protruding from the sheet width direction edge 80e adheres to the guide rib 62, the glue adhering to the guide rib 62 can be transferred onto the next label sheet 80 to be cleaned. In the case in which a plurality of the label sheets 80 of the same size is continuously conveyed, it is preferable to effectively suppress the conveyance jam.

The system controller 100 further includes the movement timing controller 100c for controlling the movement timing of the guide 61 and the conveyance roller 36 to stop the movement of the guide 61 and the conveyance roller 36 in the sheet width direction V2 if the width of the label sheet 80 to be conveyed next differs from that of the label sheet 80 one sheet before, and in this way, the following effects are achieved. By stopping the movement of the guide 61 and the conveyance roller 36 in the sheet width direction V2 if the width of the label sheet 80 to be conveyed next is shorter than the width of the label sheet 80 one sheet before, the overlapping position between the sheet width direction edge 80e of each label sheet 80 and the guide rib 62 can be different from each other. By making the overlapping position between the sheet width direction edge 80e of each label sheet 80 and the guide rib 62 different from each other, even if the glue protrudes from the sheet width direction edge 80e, it is possible to suppress the glue from stacking at the same position of the guide rib 62. On the other hand, if the width of the label sheet 80 to be conveyed next is longer than the width of the label sheet 80 one sheet before, by stopping the movement of the guide 61 and the conveyance roller 36 in the sheet width direction V2, it is possible to position the guide rib 62 that overlaps with the sheet width direction edge 80e of the label sheet 80 one sheet before at the inside of the sheet width direction edge 80e of the next label sheet 80 to be conveyed next. Even if the glue that protrudes from the sheet width direction edge 80e of the label sheet 80 one sheet before adheres to the guide rib 62, it is possible to transfer the glue adhering to the guide rib 62 onto the label sheet 80 to be conveyed next to be cleaned. Therefore, it is possible to suppress the conveyance jam.

The printer section 18 includes the fixing device 34 which applies heat to the label sheet 80 to fix the image. The guide 61 and the conveyance roller 36 are located at the downstream side of the fixing device 34 in the sheet conveyance direction V1. With the above constitution, the following effects are achieved. If the guide 61 and the conveyance roller 36 are located at the downstream side of the fixing device 34 in the sheet conveyance direction V1, as the label sheet 80 is heated bypassing through the fixing device 34, a little amount of the glue easily protrudes from the sheet edge 80e, and thus, there is a high possibility that the glue protruding from the sheet edge 80e adheres to the guide 61 or the conveyance roller 36 and stacks thereon. According to the embodiment, as the guide 61 and the conveyance roller 36 move in the sheet width direction V2, even if the glue protrudes from the sheet width direction edge 80e, it is possible to prevent the glue from stacking at the same position of the guide 61 or the conveyance roller 36. Therefore, it is possible to effectively suppress the conveyance jam. In particular, if the guide 61 and the conveyance roller 36 are located immediately after the fixing device 34, even if the glue protruding from the sheet width direction edge 80e adheres to the guide 61 or the conveyance roller 36, the glue immediately after adhesion can be easily transferred onto the next label sheet 80 to be cleaned. If the guide 61 and the conveyance roller 36 are arranged immediately after the fixing device 34, it is preferable as the conveyance jam can be effectively suppressed.

The modification is described below.

The movement mechanism 70 is not limited to moving the guide 61 and the conveyance roller 36 in the sheet width direction V2. For example, the movement mechanism 70 may move either the guide 61 or the conveyance roller 36 in the sheet width direction V2. The movement mechanism 70 may move at least one of the guide 61 and the conveyance roller 36 in the sheet width direction V2.

The rack member 72 is not limited to regulating the movement of the shaft 68 in the sheet width direction V2. For example, the rack member 72 may allow the movement of the shaft 68 in the sheet width direction V2. If the rack member 72 moves in the sheet width direction V2, the conveyance roller 36 fixed to the shaft 68 may stop moving in the sheet width direction V2.

The rack member 72 is not limited to regulating the movement of the guide 61 in the sheet width direction V2. For example, the rack member 72 may allow the movement of the guide 61 in the sheet width direction V2. If the rack member 72 moves in the sheet width direction V2, the guide 61 may stop moving in the sheet width direction V2.

The guide 61 and the conveyance roller 36 are not limited to being arranged at the downstream side of the fixing device 34 in the sheet conveyance direction V1. For example, the guide 61 and the conveyance roller 36 may be arranged between the intermediate transfer belt 21 and the fixing device 34 in the sheet conveyance direction V1. The guide 61 and the conveyance roller 36 may be located at the downstream side of the printer section 18 in the sheet conveyance direction V1.

The system controller 100 is not limited to controlling the movement mechanism 70 in such a manner that the guide 61 and the conveyance roller 36 move in the sheet width direction V2. For example, the movement mechanism 70 may unconditionally move the guide 61 and the conveyance roller 36 in the sheet width direction V2 without control. For example, the movement mechanism 70 may include a motor and a cam mechanism so that the guide 61 and the conveyance roller 36 are alternately and constantly moved in the first direction V21 and the second direction V22.

The fixing device 34 is not limited to including the heat roller 45 and the belt 53. For example, the fixing device 34 may include a fixing belt and a pressure roller.

It is not limited that there is no margin between the edge 82e of the mount 82 and the edge 81e of the label paper 81. For example, a margin may be provided between the edge 82e of the mount 82 and the edge 81e of the label paper 81. The margins may be provided on both sides in the sheet width direction V2 of the label sheet 80. The margin may be provided all around the label sheet 80.

According to the image forming apparatus of at least one embodiment described above, the conveyance jam can be suppressed.

The function of the image forming apparatus in the embodiment described above may be realized by a computer. In that case, it may be realized by recording a program for realizing the function in a computer-readable recording medium and enabling a computer system to read and execute the program recorded in the recording medium. The “computer system” mentioned above includes an OS or hardware such as peripheral devices. The “computer-readable recording medium” refers to a portable medium such as a flexible disk, a magneto-optical disk, a ROM, a CD-ROM and the like, or a storage device such as a hard disk built in the computer system. Furthermore, the “computer-readable recording medium” may also include a medium for dynamically holding the program for a short time, such as a communication wire for transmitting the program via a network such as an Internet or a communication line such as a telephone line, or a medium for holding the program for a certain time such as a volatile memory inside a computer system serving as a server or a client in that case. The program mentioned above may be used for realizing a part of the above-described functions, or may be used to realize the above-described function by a combination with a program already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
an image forming section configured to form an image on an image receiving medium;
a guide, arranged at a downstream side of the image forming section in a conveyance direction of the image receiving medium, configured to guide the image receiving medium;
a conveyance roller, arranged at the downstream side of the image forming section in the conveyance direction of the image receiving medium, configured to convey the image receiving medium along the guide;
a movement mechanism configured to move the guide in a direction intersecting the conveyance direction of the image receiving medium before conveying a second image receiving medium by the conveyance roller after conveying a first image receiving medium by the conveyance roller; and
a movement amount controller configured to control a movement amount of the guide in such a manner that the guide moves towards an edge of the second image receiving medium in the direction intersecting the conveyance direction of the second image receiving medium, the guide overlaps with an edge of the first the image receiving medium in the direction intersecting the conveyance direction of the first image receiving medium.

2. (canceled)

3. The image forming apparatus according to claim 1, further comprising:
a movement direction controller configured to control a movement direction of at least one of the guide or the conveyance roller in such a manner that at least one of the guide or the conveyance roller moves alternately from one side to an other side in the direction intersecting the conveyance direction of the image receiving medium each time one image receiving medium is conveyed when a plurality of the image receiving media is conveyed continuously.

4. (canceled)

5. The image forming apparatus according to claim 1, further comprising:
a movement timing controller configured to control a movement timing of at least one of the guide or the conveyance roller to stop the movement of at least one of the guide or the conveyance roller in the direction intersecting the conveyance direction of the image receiving medium when a width of an image receiving medium to be conveyed next differs from that of an image receiving medium one sheet before.

6. The image forming apparatus according to claim 1, wherein
the image forming section includes a fixing device configured to apply heat to the image receiving medium to fix the image, and
the guide and the conveyance roller are arranged at the downstream side of the fixing device in the conveyance direction of the image receiving medium.

7. The image forming apparatus according to claim 1, wherein the direction intersecting the conveyance direction is an image receiving medium width direction.

8. (canceled)

9. (canceled)

10. The image forming apparatus according to claim 1, wherein the guide includes one or more ribs extending in the conveyance direction arranged to support the image receiving medium.

11. The image forming apparatus according to claim 1, wherein the movement mechanism comprises a rack member configured to regulate movement of at least one of the conveyance roller or the guide in the direction intersecting the conveyance direction of the image receiving medium.

12. The image forming apparatus according to claim 3, wherein the one side and the other side are opposite sides.

13. (canceled)

14. An image forming method, comprising:
forming an image on an image receiving medium;
guiding the image receiving medium in a conveyance direction of the image receiving medium via a guide arranged at a downstream side from where the image is formed;
conveying the image receiving medium along the guide via a conveyance roller in the conveyance direction of the image receiving medium, the conveyance roller arranged at the downstream side from where the image is formed;
moving the guide in a direction intersecting the conveyance direction of the image receiving medium before conveying a second image receiving medium by the conveyance roller after conveying a first image receiving medium by the conveyance roller; and
controlling a movement amount of the guide in such a manner that the guide moves towards an edge of the second image receiving medium in the direction intersecting the conveyance direction of the second image receiving medium, the guide overlaps with an edge of the first the image receiving medium in the direction intersecting the conveyance direction of the first image receiving medium.
